(19) United States
(12) Patent Application Publication
(10) Pub. No.: US 2023/0342189 A1
(43) Pub. Date: Oct. 26, 2023

(54) Hardware Element Abstraction

(71) Applicant: Apple Inc., Cupertino, CA (US)

(72) Inventors: Matthew S. Koonce, San Jose, CA (US); Eugene Dvortsov, Cupertino, CA (US); Michael A. Gorbach, Scotts Valley, CA (US); Michael J. Lamb, San Jose, CA (US); Kevin M. Lynch, Woodside, CA (US)

(21) Appl. No.: 18/306,509

(22) Filed: Apr. 25, 2023

Related U.S. Application Data
(60) Provisional application No. 63/363,518, filed on Apr. 25, 2022.

(51) Int. Cl. G06F 9/48; G06F 9/455

(52) U.S. Cl. CPC G06F 9/4843; G06F 9/45504

(57) ABSTRACT

Implementing a configurable input component includes detecting user input via a configurable input component of a device, determining, by the device, context information, and identifying a set of actions associated with a first application. A next action is selected based on the context information, and the application is caused to perform the selected next action.

### TECHNICAL FIELD

Embodiments described herein relate to input technology for mobile devices. More particularly, embodiments described herein relate to providing an abstraction layer.

### BACKGROUND

Portable, wearable electronic devices typically have limited input components due to their small form factor. For example, a watch typically may have 1-2 buttons and/or a small touch display on the face. Traditionally, a hardware element such as a button can be configured to perform a predetermined action when pressed. However, the computing capabilities of these small wearable devices is rapidly increasing, providing functionality for many different kinds of applications. As such, improvements are needed to input mechanisms to support increasing functionality of the device.

### BRIEF DESCRIPTION OF THE DRAWINGS

Embodiments described herein are illustrated by examples and not limitations in the accompanying drawings, in which like references indicate similar features. Furthermore, in the drawings, some conventional details have been omitted, so as not to obscure the inventive concepts described herein.

FIG. 1 illustrates, in block diagram form, a network diagram in which a configurable input component may be used, according to one or more embodiments.

FIG. 2 illustrates a flow diagram for performing actions in accordance with a configurable input component, in accordance with one or more embodiments.

FIG. 3 illustrates, in flowchart form, a technique for utilizing a configurable input component, in accordance with one or more embodiments.

FIG. 4 illustrates a flow diagram for performing actions in accordance with a configurable input component, in accordance with one or more embodiments.

FIG. 5 illustrates a simplified functional block diagram of an illustrative programmable electronic device, in accordance with an embodiment.

### DETAILED DESCRIPTION

This disclosure pertains to systems, methods, and computer readable media for providing a user input component that is user- and app-configurable and for which input is obscured from third party apps. This disclosure also relates to one or more APIs which act as an abstraction layer between the user input component and the applications using the user input such that user privacy is secured.

In one or more embodiments, first- and third-party applications (“apps”) can be configured to interact with the button to perform one or more actions upon activation. In the prior art, the application would typically “listen” for a button push in order to perform an action. According to one or more embodiments, the one or more APIs may act as an abstraction layer, detecting the user input in the system, and transmitting a signal to the application to perform the action. As such, the application merely receives a notification to perform the action without concern for the context or events that caused the instruction. One advantage is user privacy, by shielding the app from user activity that caused the instruction. Another advantage is improved flexibility in the application. For example, one built, the application can run even if the hardware related to the user configurable input device changes. That is, because the app merely receives a signal to perform an action and does not listen for a particular user input, the app may be flexible across platforms. Accordingly, embodiments described herein decouple, via abstraction, the link between the signal from the user input and the action to be performed by the applications.

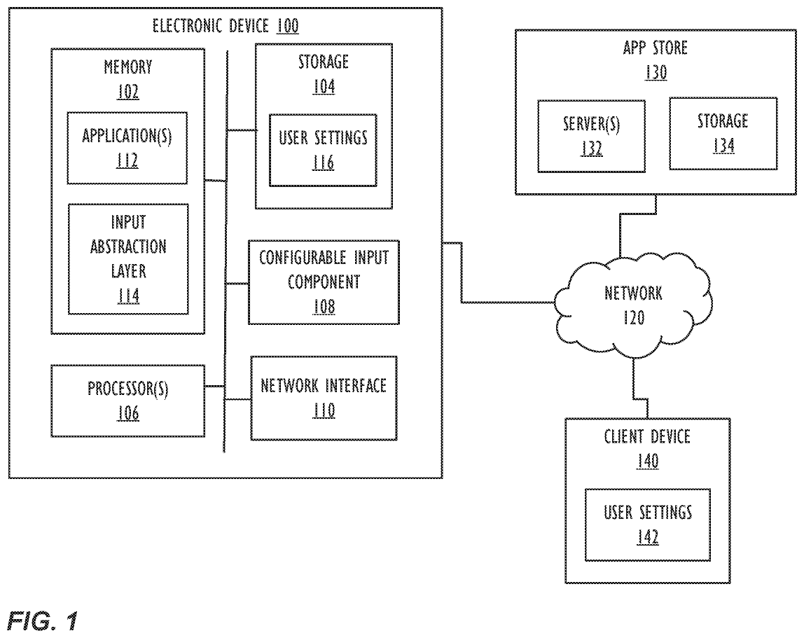

Turning to FIG. 1, the embodiments described herein can operate within and interface with applications from an app store from which one or more users, using client devices, can search for and download one or more applications (also referred to as apps). An app store 130 can include one or more servers, such as servers 132, that can provide the functionality described herein. For example, server(s) 132 can interface with a client device 140 or other devices such as electronic device 100 to provide third party apps. Storage 134 can store data related to the apps. Electronic device 100 and client device 140 can take a variety of different forms (e.g., tablet computer such as an iPad, smartphone such as an iPhone, laptop computer, desktop computer, network media player such as an Apple TV, game/entertainment system, wearable devices such as a head mounted device, watch, or the like, or other consumer electronic device). Electronic device 100 and client device 140 can be coupled to the app store 100 by one or more networks 120, such as the Internet, which provides for the data communication between the client devices and the app store so that the client devices can send search queries to the app store, receive search results and send requests to download one or more apps and then receive the downloads of the one or more apps.

According to one or more embodiments, electronic device 100 may be a user device configured to run one or more applications 112. Electronic device may be communicably coupled to the app store 130 over network 120 via a network interface 110. The applications 112 are processed by one or more processor(s) 106 from a memory 102. Processor(s) 106 may include one or more different kinds of processors, such as a central processing unit (CPU), graphical processing unit (GPU), and the like. In some embodiments, processor(s) 106 may be a system-on-chip. Memory 102 may include memory cache, read-only memory (ROM), and/or random access memory (RAM). Storage 104 may store suitable data for performing the applications 112, such as user settings 116 and other data. Storage 104 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM).

Electronic device may include a configurable input component 108. The configurable input component 108 may be an input mechanism for which an associated action, when activated, is configurable by a user, for example in user settings 116. The configurable input component may be, for example, a mechanical button, a digital button, or other input mechanism. That is, the users input component may be a hardware component, software component, or other input component. According to some embodiments, the user can configure the button to cause particular actions offered by one or more applications 112. In particular, the input abstraction layer may be a system-level module which facilitates one or more application program interfaces (APIs) to cause the app to perform an action.

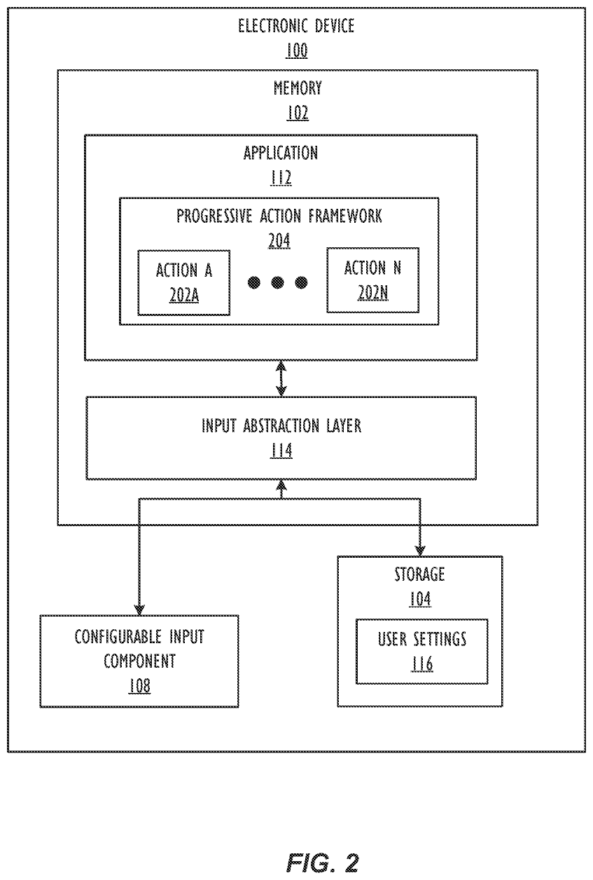

Turning to FIG. 2, a flow diagram is presented showing a system architecture in which embodiments of the disclosure may be practiced. The flow diagram includes a memory 102 of the electronic device 100. According to one or more embodiments, the memory 102 includes the application 112 and the input abstraction layer 114. The application 112 may include, for example, a first- or third-party application from the perspective of the electronic device 100.

According to one or more embodiments, the application layer 112 may include a progressive action framework 204. The progressive action framework may be a set of actions 202A-202N performable by the application which are configured to be performed in a particular order. According to one or more embodiments, actions are units of functionality within the application 112. The application 112 may host one or more sets of actions. Each set of actions may be associated with an action type. Examples of action types include, but are not limited to, Workout, Stopwatch, Flashlight, Waypoint, Backtrack, Dive, and Shortcut. In some embodiments, the various action types may be available for implementation in a first- and/or third-party application. To utilize the configurable input component, the application 112 may be configured to communicate with an API associated with the input abstraction layer 114. The application 112 may provide a set of actions 202A-202N for the action type, which may each be associated with a particular context under which they should be performed.

According to one or more embodiments, the application 112 may make available the progressive action framework 204 and the actions 202A-202N to the system, for example during installation. The progressive action framework and the associated actions indicate how the application should perform when the configurable input component is activated. The configurable input component may also be configurable by a user. That is, the configurable input component can be assigned a selected action type by a user. As such, the selected action type for the configurable component 108 may be stored in user setting 116, for example in storage 104 or in network storage in association with a user profile.

In some embodiments, the progressive action framework 204 includes a series of actions 202A-202N performed within a session. In some embodiments, the session may be initiated when the application 112 initiates an initial action, such as Action A 202A. In some embodiments, a session may be initiated separately from input via the configurable input component 108, or through other means, such as an input component for the application 112.

In some embodiments, the application 112 may provide context information to the input abstraction layer to indicate a current state of the progressive action framework 204. The context information may be provided in the form of a “donation,” which is data indicative of the state of the application 112, provided by the application 112. In some embodiments, the donation may provide an indication of what is currently happening in the application, a current action of the progressive action framework 204 being performed, and/or a next action of the progressive action framework 204 that should be performed. As such, the donation will allow applications to communicate to the input abstraction layer 114 information required to determine what is most relevant at a given moment.

According to one or more embodiments, when the configurable input component 108 is activated, the input abstraction layer 114 can identify the set of actions to be performed, for example from user settings 116. The user settings 116 may thus indicate that activation of the configurable input component 108 should relate to an action type associated with actions 202A-202N. Then, the input abstraction layer 114 can determine the most recent and relevant action from actions 202A-202N and invoke the determined in the application 112. Accordingly, the input abstraction layer 114 allows for the configurable input component 108 to perform pre-defined and independent “actions”, rather than provide input which needs to be interpreted.

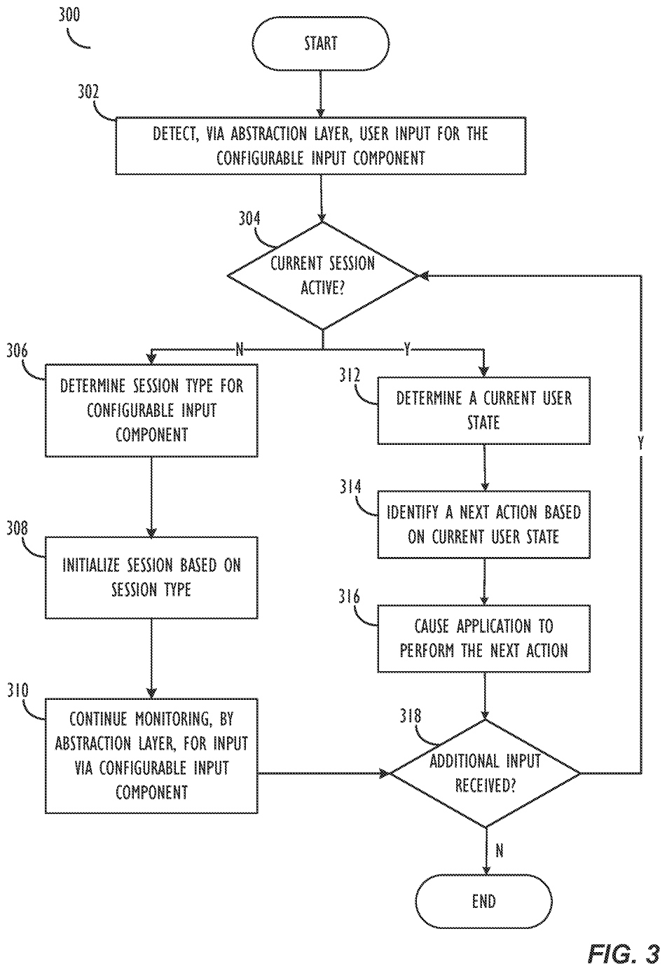

FIG. 3 depicts a flow chart of a technique for utilizing a configurable input component according to one or more embodiments. Although the various actions are depicted in a particular order, in some embodiments the various actions may be performed in a different order. In still other embodiments, two or more of the actions may occur simultaneously. According to yet other embodiments, some of the actions may not be required or other actions may be included. For purposes of clarity, the flowchart will be described with respect to the various components of FIG. 1. However, it should be understood that the various actions may be taken by alternative components, according to one or more embodiments.

The flowchart 300 begins at bloc 302 where the abstraction layer detects user input via the configurable input component. As described above, configurable input component may be a mechanical component, electronic component, digital component, or the like. In some embodiments, the abstraction layer may be configured to detect when the configurable input component is activated. The configurable input component may be activated, for example, based on a user action, such as a press, a selection, or the like.

The flowchart continues at block 304 and a determination is made regarding whether a current session is active. In some embodiments, the configurable input component may be associated with a particular action type, for which a set of actions may be provided, for example by an application. The determination at 304 may be related to the user-configurable action type. That is, the abstraction layer may determine whether a session is active for the particular action type selected by the user from user settings. As described above, in some embodiments, the application may provide the progressive action framework that includes a series of actions that may be performed serially, or in a particular order. The session may be initiated by the configurable input component, or by other input or device action. For example, in some embodiments, a user may select an app-provided input component to perform the first action in the session. As another example, in some embodiments, the first action may initiate automatically, for example based on user context and/or device context.

If, at block 304, a determination is made that there is not currently active session, then the flowchart continues at block 306 and a session type is determined for the configurable input component. As described above, in some embodiments, the user may select an action type to be performed by the configurable input component. Thus, the session type may be determined based on user-configuration. Then, at block 308, the session is initialized based on session type. According to some embodiments, the application may implement an initialization action, and implement an associated background function. As such, when the configurable input component is activated while not in a session, an initialization action is invoked and the session is initiated.

The flowchart continues at block 310 and the abstraction layer continues monitoring for input via the configurable input component. In some embodiments, the abstraction layer may additionally monitor for context information received from the application, for example in the form of donations. As such, the abstraction layer can track a next action that should be performed upon detecting user input via the configurable input component.

Returning to block 304, if a determination is made that there is a session currently active, then the flowchart continues at block 312. At block 312, once a session is running, the abstraction layer may obtain context information from which a state of the application can be determined. In some embodiments, the abstraction layer may query context information from the application and/or other system components. Additionally, or alternatively, the application may, from time to time, submit or provide context information to the abstraction layer in the form of donations. Thus, the current state may be determined on demand, or may be determined continuously. In some embodiments, the current state may refer to a last action being performed or a current action being performed out of the set of actions in the progressive action framework. The current user state may be determined based on context information provided by the app in the form of a donate function. As such, the abstraction layer can track a history of actions invoked by the abstraction layer, as well as actions invoked by other means. For example, if a Workout was started by another mechanism, such as an in-app button, then the application may use the donate function to indicate to the abstraction layer that the next action is not the initialization action, but another action in the framework.

At block 314, a next action is identified based on a current user state. logically determine which action should be performed next such that the flow of actions are performed intuitively during the session. According to some embodiments, when the application performs an operation that affects an action that should be performed next, the app may provide the context information such that a next action is assigned to the configurable input component accordingly. For example, while running on a track, input via the configurable input component may be used to mark a lap. For other types of exercise, for example a hockey tracker app, the configurable input component could be used to mark a scored goal. These in-session actions can be custom and can be defined by the app.

According to some embodiments, when the abstraction layer determines a next action, the system also displays a notification to the user of the system about the new button functionality. This notification can improve the user interface by educating users about the new behavior within the app. For example, when a workout is active, a next action may be a pause workout action. As another example, if the action type is running, a next action may be a new lap demarcation action.

The flowchart 300 continues to block 316, and the application is signaled to cause the system to perform the next action. Accordingly, a single press within a session can cause a progressive action within an application-defined framework of actions.

Once the action is performed at 316, or, during the monitoring of block 310, a determination is made as to whether additional input is received at block 318. If, at block 318, no additional input is received, then the flowchart concludes. However, if at block 318, additional input is received via the configurable input component, then the flowchart returns to block 304, and a determination is made regarding whether a current session is active. For example, in some embodiments a session may time out, or may exit after a last action of the progressive action framework. The flowchart then proceeds and additional actions are performed.

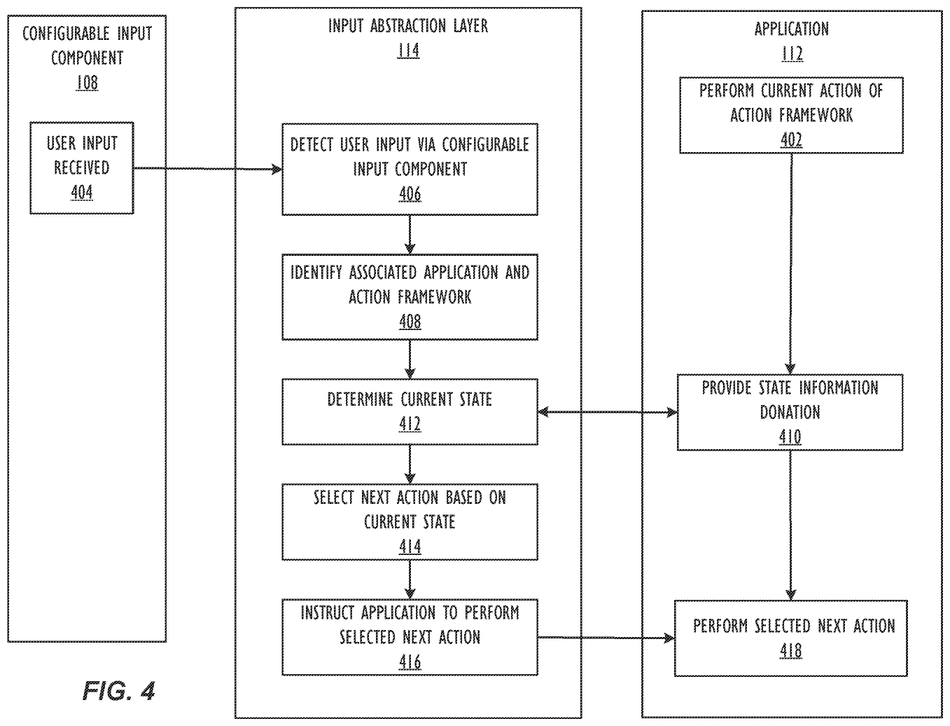

FIG. 4 depicts a flow diagram of a technique for using the configurable input component 108, according to some embodiments. Initially, at 402, at application 112 performs a current action of the progressive action framework. At block 404, user input is received via the configurable input component. As such, the input may be received while the application is performing a particular action. The input is detected, by the input abstraction layer 114, at block 406.

In response to detecting the input via the configurable input component, the flow diagram continues to block 408 and an application is identified by the input abstraction layer 114 in association with the configurable input component. For example, the input abstraction layer can determine, from user settings, what application and/or action type the configurable input component should be associated with.

At block 410, in some embodiments, the application 112 can provide contextual data in the form of a donation, from which the input abstraction layer 114 can determine a current state, as shown at 412. In some embodiment, the contextual information may include a history of actions performed, a current user action, a current action being performed, current processing state of the application, and the like. At block 412, the current state may be determined, for example, based on the provided state information. Additionally, or alternatively, the current state may be determined based on previously performed actions in the session.

At block 414, in some embodiments, a next action may be selected among one of a set of actions that comprise a progressive framework. The app may provide, to the system, one or more predefined sets of actions which can be used as configurable actions for the user configurable input component. As such, the abstraction layer may have access to the framework. In one or more embodiments, the predefined sets of actions can be a progressive set of actions. That is, the set of actions may form a timeline based on different states of the application. At block 416, the abstraction layer can signal, or trigger, the application to perform the selected next action. From there, the input abstraction layer 114 can trigger the application to perform the next action. The flow diagram concludes at block 418, and selected next action is performed by the application 112. If, for some reason, your app is unable to perform the action throw an error from the ‘perform’ function. The system will alert the user that the action was unable to be completed.

According to some embodiments, the user input component should behave as a precise input into the system. To account for any delays introduced between the activation of the configurable input component through the software stack, a functionality may be applied to resolve the latency of the timestamp.

In accordance with the embodiments described above, the app may not receive a signal from the configurable input component being activated, and instead receives only an indication that the app should move to its next state or should specify its next action. As such, the state information of an app is updated based on progressions in the app.

According to some embodiments, not allowing the app to detect that the button is pressed or to receive a signal from the configurable input component allows for user privacy and for forward configurability o an action-based framework. As such, when future hardware is rec=leased with different input components, an app that specifies a next action via an abstraction layer that does not rely on a signal from the configurable input component can continue to operate with future updates to the same device, and can work with new devices because those updated or new devices can specify which inputs trigger the next action functionality.

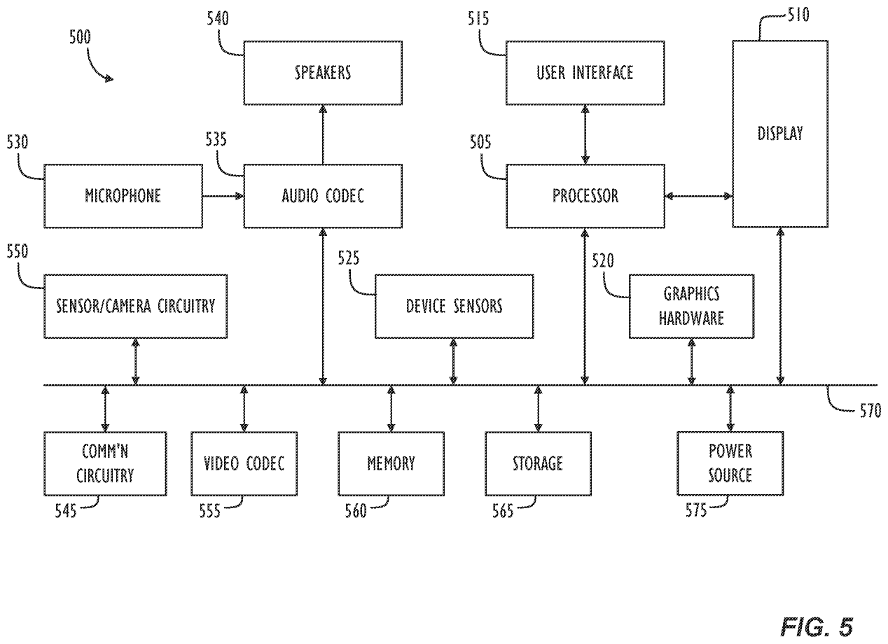

Referring now to FIG. 5, a simplified functional block diagram of an illustrative programmable electronic device 500 for providing access to an app store is shown, according to one embodiment. Electronic device 500 could be, for example, a mobile telephone, personal media device, portable camera, or a tablet, notebook or desktop computer system. As shown, electronic device 500 may include processor 505, display 510, user interface 515, graphics hardware 520, device sensors 525 (e.g., proximity sensor/ambient light sensor, accelerometer and/or gyroscope), microphone 530, audio codec(s) 535, speaker(s) 540, communications circuitry 545, image capture circuit or unit 550, which may, e.g., comprise multiple camera units/optical sensors having different characteristics (as well as camera units that are housed outside of, but in electronic communication with, device 500), video codec(s) 555, memory 560, storage 565, and communications bus 570.

Processor 505 may execute instructions necessary to carry out or control the operation of many functions performed by device 500 (e.g., such as the generation and/or processing of DAs in accordance with the various embodiments described herein). Processor 505 may, for instance, drive display 510 and receive user input from user interface 515. User interface 515 can take a variety of forms, such as a button, keypad, dial, a click wheel, keyboard, display screen and/or a touch screen. User interface 515 could, for example, be the conduit through which a user may view a captured video stream and/or indicate particular images(s) that the user would like to capture or share (e.g., by clicking on a physical or virtual button at the moment the desired image is being displayed on the device's display screen).

In one embodiment, display 510 may display a video stream as it is captured while processor 505 and/or graphics hardware 520 and/or image capture circuitry contemporaneously store the video stream (or individual image frames from the video stream) in memory 560 and/or storage 565. Processor 505 may be a system-on-chip such as those found in mobile devices and include one or more dedicated graphics processing units (GPUs). Processor 505 may be based on reduced instruction-set computer (RISC) or complex instruction-set computer (CISC) architectures or any other suitable architecture and may include one or more processing cores. Graphics hardware 520 may be special purpose computational hardware for processing graphics and/or assisting processor 505 perform computational tasks. In one embodiment, graphics hardware 520 may include one or more programmable graphics processing units (GPUs).

Image capture circuitry 550 may comprise one or more camera units configured to capture images, e.g., in accordance with this disclosure. Output from image capture circuitry 550 may be processed, at least in part, by video codec(s) 555 and/or processor 505 and/or graphics hardware 520, and/or a dedicated image processing unit incorporated within circuitry 550. Images so captured may be stored in memory 560 and/or storage 565. Memory 560 may include one or more different types of media used by processor 505, graphics hardware 520, and image capture circuitry 550 to perform device functions. For example, memory 560 may include memory cache, read-only memory (ROM), and/or random access memory (RAM). Storage 565 may store media (e.g., audio, image and video files), computer program instructions or software, preference information, device profile information, and any other suitable data. Storage 565 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 560 and storage 565 may be used to retain computer program instructions or code organized into one or more modules and written in any desired computer programming language. When executed by, for example, processor 505, such computer program code may implement one or more of the methods described herein. Power source 575 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 500.

In the foregoing description, numerous specific details are set forth, such as specific configurations, properties, and processes, etc., in order to provide a thorough understanding of the embodiments. In other instances, well-known processes and manufacturing techniques have not been described in particular detail in order to not unnecessarily obscure the embodiments. Reference throughout this specification to “one embodiment,” “an embodiment,” “another embodiment,” “other embodiments,” “some embodiments,” and their variations means that a particular feature, structure, configuration, or characteristic described in connection with the embodiment is included in at least one embodiment. Thus, the appearances of the phrase “for one embodiment,” “for an embodiment,” “for another embodiment,” “in other embodiments,” “in some embodiments,” or their variations in various places throughout this specification are not necessarily referring to the same embodiment. Furthermore, the particular features, structures, configurations, or characteristics may be combined in any suitable manner in one or more embodiments.

In the following description and claims, the terms “coupled” and “connected,” along with their derivatives, may be used. It should be understood that these terms are not intended as synonyms for each other. “Coupled” is used herein to indicate that two or more elements or components, which may or may not be in direct physical or electrical contact with each other, co-operate or interact with each other. “Connected” is used to indicate the establishment of communication between two or more elements or components that are coupled with each other.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing system, that manipulates and transforms data represented as physical (electronic) quantities within the computer system's registers and memories into other data similarly represented as physical quantities within the computer system memories or registers or other such information storage, transmission or display devices.

Embodiments described herein can relate to an apparatus for performing a computer program (e.g., the operations described herein, etc.). Such a computer program may be stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

Although operations or methods are described above in terms of some sequential operations, it should be appreciated that some of the operations described may be performed in a different order. Moreover, some operations may be performed in parallel, rather than sequentially. Embodiments described herein are not described with reference to any particular programming language. It will be appreciated that a variety of programming languages may be used to implement the various embodiments of the disclosed subject matter. In utilizing the various aspects of the embodiments described herein, it would become apparent to one skilled in the art that combinations, modifications, or variations of the above embodiments are possible for managing components of a processing system to increase the power and performance of at least one of those components. Thus, it will be evident that various modifications may be made thereto without departing from the broader spirit and scope of at least one of the disclosed concepts set forth in the following claims. The specification and drawings are, accordingly, to be regarded in an illustrative sense, rather than a restrictive sense.

In the development of any actual implementation of one or more of the disclosed concepts (e.g., such as a software and/or hardware development project, etc.), numerous decisions must be made to achieve the developers' specific goals (e.g., compliance with system-related constraints and/or business-related constraints). These goals may vary from one implementation to another, and this variation could affect the actual implementation of one or more of the disclosed concepts set forth in the embodiments described herein. Such development efforts might be complex and time-consuming, but may still be a routine undertaking for a person having ordinary skill in the art in the design and/or implementation of one or more of the inventive concepts set forth in the embodiments described herein.

As used in the description above and the claims below, the phrases “at least one of A, B, or C” and “one or more of A, B, or C” include A alone, B alone, C alone, a combination of A and B, a combination of B and C, a combination of A and C, and a combination of A, B, and C. That is, the phrases “at least one of A, B, or C” and “one or more of A, B, or C” means A, B, C, or any combination thereof, such that one or more of a group of elements consisting of A, B and C, and should not be interpreted as requiring at least one of each of the listed elements A, B and C, regardless of whether A, B and C are related as categories or otherwise. Furthermore, the use of the article “a” or “the” in introducing an element should not be interpreted as being exclusive of a plurality of elements. Also, the recitation of “A, B, and/or C” is equal to “at least one of A, B, or C.” Also, the use of “a” refers to “one or more” in the present disclosure. For example, “a DA” refers to “one DA” or “a group of DAs.”

What is claimed is:

1. A method, comprising:
detecting user input via a configurable input component of a device;
determining, by the device, context information;
identifying a set of actions associated with a first application;
selecting, based on the context information, a next action of the set of actions; and
causing the application to perform the selected next action.

2. The method of claim 1, wherein determining the context information comprises determining a currently active session, wherein the set of actions are associated with the currently active session.

3. The method of claim 1, wherein the set of actions are defined by the first application.

4. The method of claim 1, wherein the set of actions are further identified in accordance with user profile data indicating a user-defined configuration for the configurable input component.

5. The method of claim 1, where in the set of actions comprise a plurality of progressive application-performable actions.

6. The method of claim 1, wherein an abstraction layer causes the application to perform the selected next action without indicating that the user input is detected via the user configurable input component.

7. The method of claim 1, wherein the context information is determined, in part, by state information received from the first application.

8. A non-transitory computer readable medium comprising computer readable code executable by one or more processors to:
detect user input via a configurable input component of a device;
determine, by the device, context information;
identify a set of actions associated with a first application;
select, based on the context information, a next action of the set of actions; and
cause the application to perform the selected next action.

9. The non-transitory computer readable medium of claim 8, wherein the computer readable code to determine the context information comprises computer readable code to determine a currently active session, wherein the set of actions are associated with the currently active session.

10. The non-transitory computer readable medium of claim 8, wherein the set of actions are defined by the first application.

11. The non-transitory computer readable medium of claim 8, wherein the set of actions are further identified in accordance with user profile data indicating a user-defined configuration for the configurable input component.

12. The non-transitory computer readable medium of claim 8, where in the set of actions comprise a plurality of progressive application-performable actions.

13. The non-transitory computer readable medium of claim 8, wherein an abstraction layer causes the application to perform the selected next action without indicating that the user input is detected via the user configurable input component.

14. The non-transitory computer readable medium of claim 8, wherein the context information is determined, in part, by state information received from the first application.

15. The system comprising:
one or more processors; and
one or more computer readable media comprising computer readable code executable by the one or more processors to:
detect user input via a configurable input component of a device;
determine, by the device, context information;
identify a set of actions associated with a first application;
select, based on the context information, a next action of the set of actions; and
cause the application to perform the selected next action.

16. The system of claim 15, wherein the computer readable code to determine the context information comprises computer readable code to determine a currently active session, wherein the set of actions are associated with the currently active session.

17. The system of claim 15, wherein the set of actions are defined by the first application.

18. The system of claim 15, wherein the set of actions are further identified in accordance with user profile data indicating a user-defined configuration for the configurable input component.

19. The system of claim 15, where in the set of actions comprise a plurality of progressive application-performable actions.

20. The system of claim 15, wherein an abstraction layer causes the application to perform the selected next action without indicating that the user input is detected via the user configurable input component.
